(19) United States
(12) Patent Application Publication
(10) Pub. No.: US 2002/0117552 A1
(43) Pub. Date: Aug. 29, 2002

(54) Snap-on sprayer assembly for spraying sweetened compositions

(76) Inventor: Keith J. Traylor, Slidell, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 09/940,841

(22) Filed: Aug. 28, 2001

Related U.S. Application Data
(60) Provisional application No. 60/228,536, filed on Aug. 28, 2000.

(51) Int. Cl. B05B 17/00

(52) U.S. Cl. 239/1

(57) ABSTRACT

A method of assembling a sprayer includes the steps of providing a bottle, providing a sprayer assembly including a nozzle, pump assembly, and overcap, placing the sprayer assembly on the bottle, and pushing down on the overcap. A sprayer apparatus includes a sprayer assembly including a nozzle, pump assembly, and overcap, and means on the sprayer assembly for connecting the sprayer assembly to a bottle. The bottle advantageously has a diameter of about 13 mm. Preferably, the sprayer assembly snaps onto the bottle. The sprayer apparatus can be used to deliver a liquid composition including sucralose and flavoring agent(s).

### CROSS-REFERENCE TO RELATED APPLICATIONS

Priority of my U.S. Provisional Patent Application Serial No.60/228,536, filed Aug. 28, 2000, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to spray bottles and sweetened compositions. More particularly, the present invention relates to snap-on assemblies for spray bottles used for spraying sweetened compositions.

2. General Background of the Invention

There exist snap-on sprayers, including screw-on and crimp-on sprayers. Typically, these sprayers come in as unassembled parts. For example, they come as follows: a crimp on sprayer pump and dip tube, an actuator (this is the nozzle part), and an over cap (this is the shell that covers the pump).

The old filling and crimping pump sprayer came in separate pieces that had to be put on one at a time on the machine, after liquid was dispensed in the bottle. First a station on the machine would drop the crimp pump sprayer over or on to the bottle, then the bottle and sprayer would move to a second station that would crimp the crimp pump sprayer onto the bottle, then the bottle and crimp pump sprayer with aluminum shell would move to the next station that would push on a actuator/nozzle, then the bottle crimp pump sprayer and actuator would move to the last station that would drop and push on the over cap. The process was long and difficult.

Sucralose is a chlorinated derivative of ordinary sugar (sucrose). U.S. Pat. No. 4,751,294, incorporated herein by reference, has information about its composition and history. It is used as a sweetener.

The following U.S. Patents are incorporated herein by reference: U.S. Pat. Nos. 3,957,178; 4,051,983; 4,189,064; 4,153,737; 4,338,346; 4,525,341; 4,770,889; 4,826,962; 5,061,320; 5,061,496; 5,158,211; 5,298,238; 5,510,123; 5,576,042; 5,725,128; 5,727,715; 5,813,571; 5,827,562; 5,918,778; 5,932,720; 5,942,214; and 6,096,362.

### BRIEF SUMMARY OF THE INVENTION

The present invention includes a method of assembling a sprayer comprising the steps of providing a bottle, providing a sprayer assembly including a nozzle, pump assembly, and overcap, placing the sprayer assembly on the bottle, and pushing down on the overcap.

The present invention also comprises a sprayer apparatus comprising a sprayer assembly including a nozzle, pump assembly, and overcap, and means on the sprayer assembly for connecting the sprayer assembly to a bottle. The bottle advantageously has a diameter of about 13 mm. Preferably, the sprayer assembly snaps onto the bottle.

The bottle can contain sucralose in a candy-flavored spray form or in a dessert-flavored spray form.

The present invention also comprises a method of delivering a liquid composition containing sucralose and flavoring agent(s) comprising placing the liquid composition including sucralose and flavoring agent(s) in a bottle, providing a sprayer assembly including a nozzle, pump assembly, and overcap, placing the sprayer assembly on the bottle, pushing down on the overcap, and actuating the sprayer assembly to spray the liquid composition including sucralose and flavoring agent(s) from the bottle. The liquid composition including sucralose and flavoring agent(s) is preferably in an aqueous vehicle.

The apparatus of the present invention can also be used to deliver sucralose in a candy-flavored spray form or in a dessert-flavored spray form, in which case preferably the sucralose is in an aqueous vehicle with flavoring.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIGS. 1-18 show the preferred embodiment of the apparatus of the present invention, with exemplary dimensions; and

FIGS. 19-23 are various views of the preferred embodiment of the apparatus of the present invention.

### DETAILED DESCRIPTION OF THE INVENTION

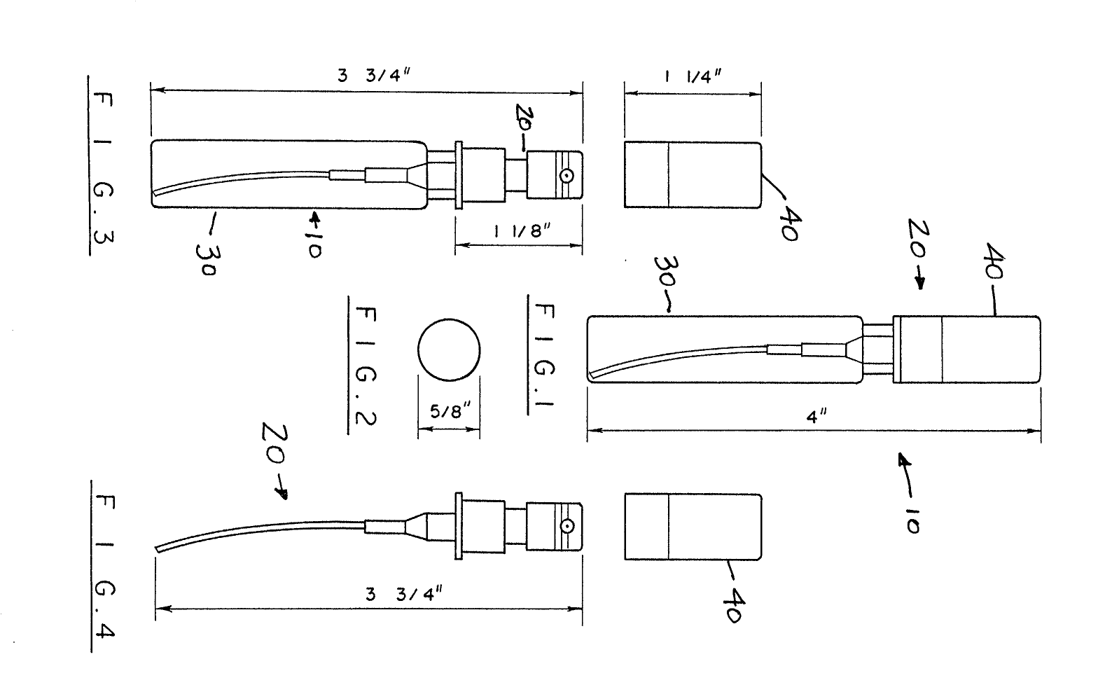

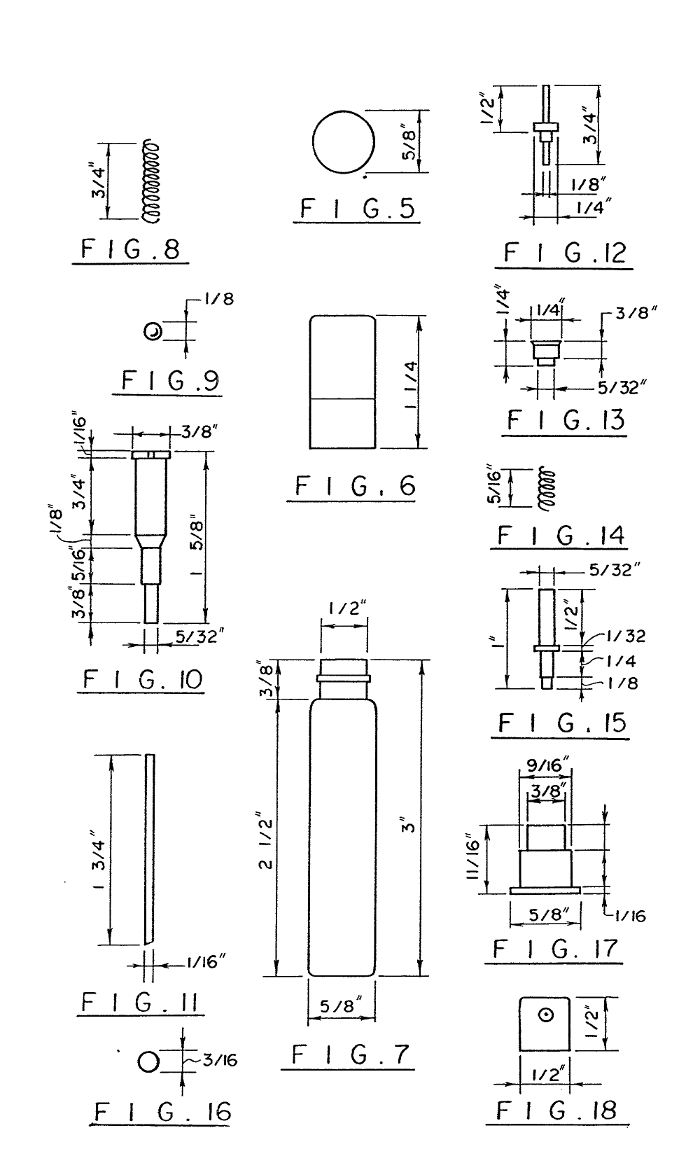

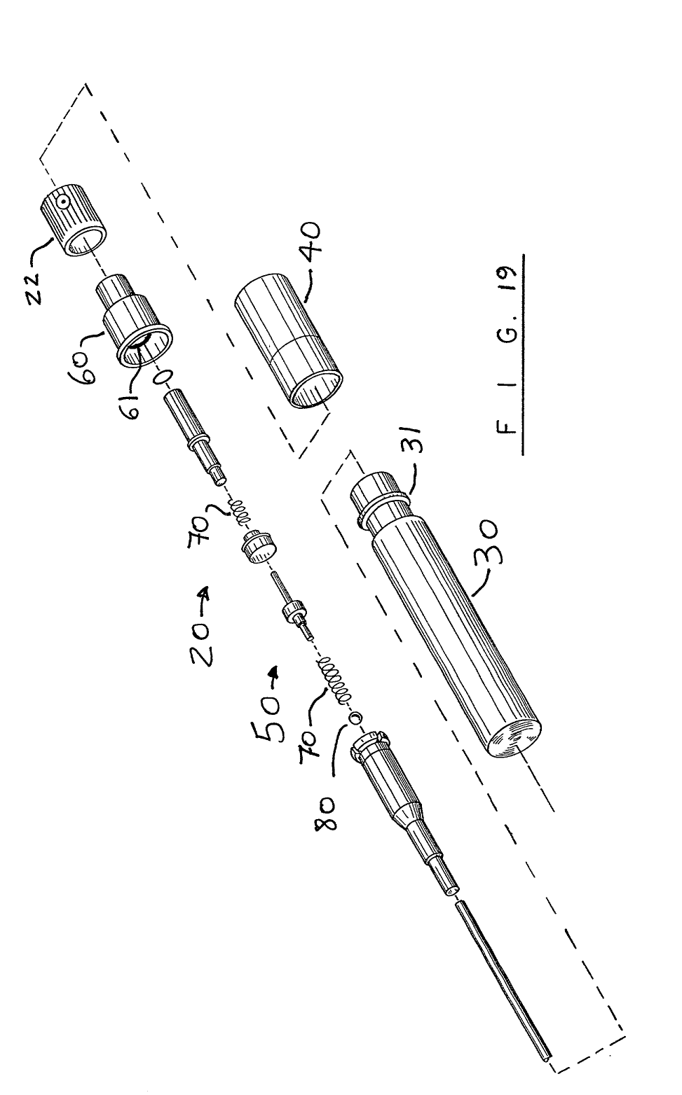

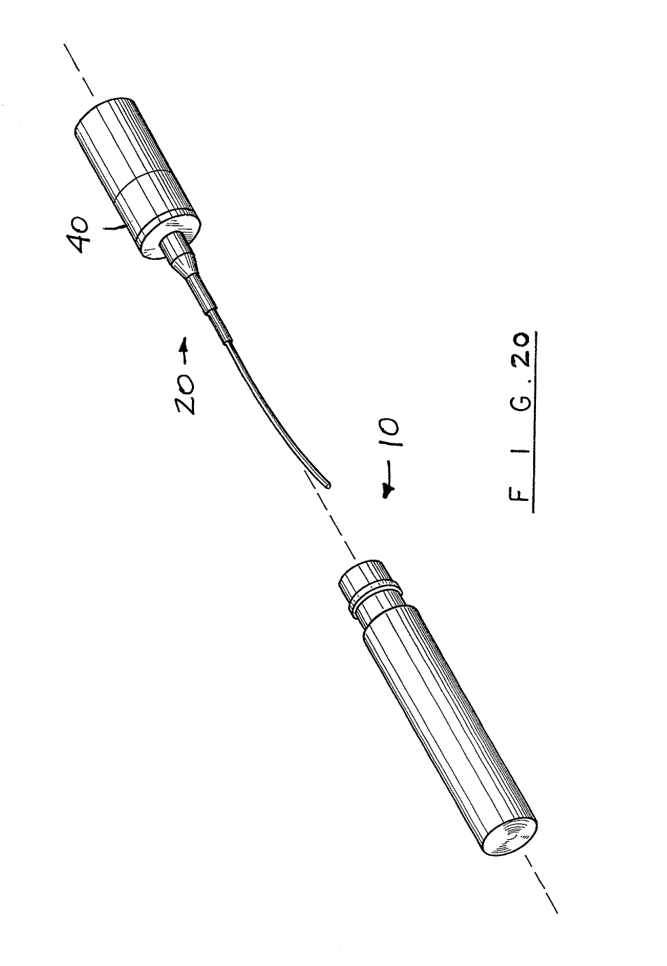

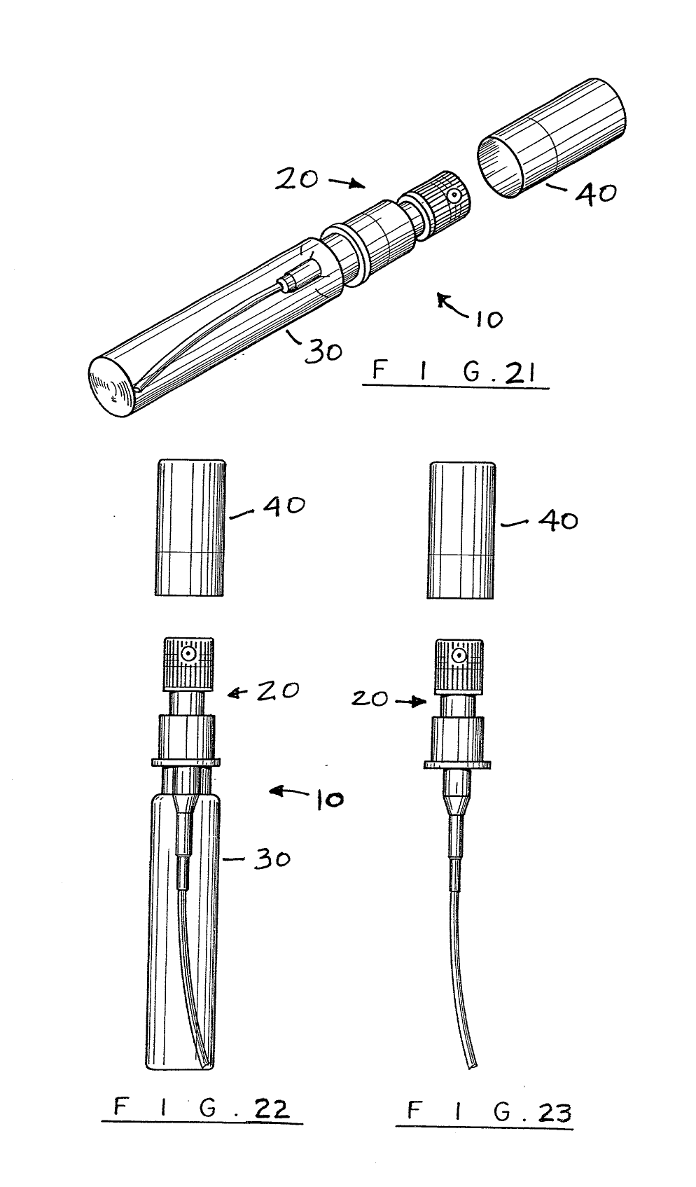

FIGS. 1-18 show a 13 mm snap-on sprayer. Other sizes, such as 15, 18, and 20 mm snap-on sizes can also be made.

Unlike old designs, which come in several parts, the spray pump assembly of the present invention arrives at a filler production facility completely assembled: a snap-on sprayer pump assembly 20 with actuator 50, nozzle 22, and over cap 40 all put together, which is better the old design.

The unique process of the design is that this sprayer 10 also saves at least 50% on production time in machine time with putting the sprayer 20 on the bottle 30.

In the new process with the newly designed snap-on sprayer 20, after liquid is dispensed in the bottle 30, the snap-on sprayer 20 is dropped onto the bottle 30, and then the apparatus is moved to a second station where the snap-on sprayer 20 is pressed onto the bottle 30. Thus the process time is cut in half, with fewer stations. Also, the room for error is reduced because the crimping process is harder with more need for precision. The new snap-on process is simple.

The present invention may be the first plastic device to snap on the outside of the bottle. It may be the first with an overcap which snaps onto a bottle. It may be the first in which the assembly is made by pushing on the overcap.

The present invention may be the first 13 mm snap on pump sprayer that uses the overcap to push the overall pump down.

The bottle 30 could be made of PET.

There is an annular ridge 31 on the bottle 30. Snap-on closure 60 has an annular groove 61 which mates with ridge 31 when snap-on closure 60 is pushed downward onto bottle 30. Snap-on closure 60 thus securely snaps onto bottle 30. Annular groove 61 is preferably close to the same size as ridge 31.

All parts of the present invention can advantageously be made of polypropylene, though the springs and ball are preferably made of steel.

The liquid composition of the present invention including sucralose and flavoring agent(s) is preferably contained in apparatus 10 and preferably is delivered in a quantity of 50-150 microliters per spray. Apparatus 10 is a microsprayer.

The liquid composition of the present invention including sucralose (or aspartame) and flavoring agent(s) can be made according to the following formulations (where percentages are by weight of the total composition). While preferably these formulations are used, one could vary the ingredients by as much as 25% without drastically changing the flavor or consistency of the product.

In the following formulations, the ingredients above the word Dissolve are added together and mixed before additional ingredients are added, then all ingredients are mixed after they are all together.

B FORMULA

| Formulas for Flavored Sprays | |
|---|---|
| Aspartame/Ace-K Formula | |
| Brown Flavored creams | Type A |
| Ingredients | Percent |
| Water, D1 | 52.95% |
| Sodium Benzoate | 0.05% |
| Potassium Sorbate | 0.05% |
| Aspartame | 0.25% |
| Acesulfame K | 0.20% |
| Sodium Citrate | 0.25% |
| Dissolve | |
| High Fructose Corn Syrup 55 | 35.00% |
| Extol N&A Flavor System | 6.00% |
| Vegetable Glycerine | 5.00% |
| Citric Acid, anhyd. | 0.15% |
| Artificial Color | 0.10% |
| Dissolve | |
| | 100.00% |
| Formulas for Flavored Sprays | |
| Sucralose Formula | |
| Brown Flavored creams | Type B |
| Ingredients | Percent |
| Water, D1 | 53.30% |
| Sodium Benzoate | 0.05% |
| Potassium Sorbate | 0.05% |
| Sucralose | 0.10% |
| Sodium Citrate | 0.25% |
| Dissolve | |
| High Fructose Corn Syrup 55 | 35.00% |
| Extol N&A Flavor System | 6.00% |
| Vegetable Glycerine | 5.00% |
| Citric Acid, anhyd. | 0.15% |
| Artificial Color | 0.10% |
| Dissolve | |
| | 100.00% |

F FORMULA

| Formulas for Flavored Sprays | |
|---|---|
| Aspartame/Ace-K Formula | |
| Berries/Fruit & Cream | Type A |
| Ingredients | Percent |
| Water, D1 | 52.10% |
| Sodium Benzoate | 0.05% |
| Potassium Sorbate | 0.05% |
| Aspartame | 0.25% |
| Acesulfame K | 0.20% |
| Sodium Citrate | 0.25% |
| Dissolve | |
| High Fructose Corn Syrup 55 | 35.00% |
| Extol N&A Flavor System | 6.00% |
| Vegetable Glycerine | 5.00% |
| Citric Acid, anhyd. | 1.00% |
| Artificial Color | 0.10% |
| Dissolve | |
| | 100.00% |

F FORMULA

| Formulas for Flavored Sprays | |
|---|---|
| Sucralose Formula | |
| Berries/Fruit & Cream | Type B |
| Ingredients | Percent |
| Water, D1 | 52.45% |
| Sodium Benzoate | 0.05% |
| Potassium Sorbate | 0.05% |
| Sucralose | 0.10% |
| Sodium Citrate | 0.25% |
| Dissolve | |
| High Fructose Corn Syrup 55 | 35.00% |
| Extol N&A Flavor System | 6.00% |
| Vegetable Glycerine | 5.00% |
| Citric Acid, anhyd. | 1.00% |
| Artificial Color | 0.10% |
| Dissolve | |
| | 100.00% |

The flavoring agents can used in the liquid composition of the present invention are preferably those which will cause the liquid composition to have one of the flavors mentioned herein. Those agents should be ascertainable by one of ordinary skill in the art reviewing the flavors mentioned herein. They can advantageously be purchased from Extol in Atlanta, Ga..

The following flavors are preferably made using the formulation whose letter follows the name of the flavor. The flavors can be made with aspartame, acesulfame K, and fructose as the sweeteners (Type A formula) or with sucralose and fructose as the sweeteners (Type B formula): Almond Cookie—B; Amaretto—B; Angel Food—B; Anise (Licorice Flavor)—B; Apple Brown Betty—B; Apple Cinnamon Cobbler—B; Apple Dumpling—F; Apple Fritter—B; Apple Pie—B; Apple Struesel—B; Apricot—F; Baklava—B; Banana Bread—F; Banana Cream—F; Banana Cream Pie—F; Banana Nut Bread—B; Banana Split—F; Banana Strawberry—F; Berry Compote—F; Black Forest Cake (Chocolate and Cherries)—B; Black Walnut—B; Blueberry Cheesecake—B; Bread Pudding—B; Butter Rum—B; Buttered Pound Cake—B; Butterscotch—B; Cappuccino—B; Caramel Custard—B; Caramel Pop Corn—B; Carrot Cake—B; Cheesecake—B; Cherries Jubilee—F; Cherry Cheesecake—B; Chocolate Almond —B; Chocolate Caramel Swirl—B; Chocolate Chip Cookie Dough—B; Chocolate Covered Cherries—B; Chocolate Covered Pretzels—B; Chocolate Layer Cake—B; Chocolate Mint Patty—B; Chocolate Peanut Butter Cups—B; Chocolate Raspberry—B; Chocolate Strawberry —B; Chocolate Strawberry, Raspberry and Almond—B; Chocolate Toffee—B; Chocolate Truffles—B; Cinnamon Apple Pie—F; Coconut Cream Pie—F; Coffee Flavor Cappuccino—B; Coffee Flavor Latte—B; Coffee Flavor Mint—B; Coffee Flavor Mocha—B; Coffee Flavor Orange—B; Cookies N Cream—B; Cranberry Pie—F; Cranberry Tart—F; Cranberry/Orange —F; Creampuff—B; Creamy Cheesecake—B; Creme Brulee—B; Creme De Menthe—B; Crepe Suzette—B; Divinity—B; Eggnog—B; Flan—B; Fruit Cake—B; Fruit Salad—F; Fudge—B; Fudge Brownie—B; Ginger Bread—B; Ginger Snap—B; Glazed Donut—B; Green Apple—F; Hot Buttered Rum—B; Hot Fudge Brownie—B; Hot Fudge Sundae—B; Ice Cream Cake—B; Jellybean—F; Key Lime Pie—F; King Cake—B; Lemon Meringue—F; Licorice—B; Maple Syrup—B; Maple Nut—B; Mint Chocolate Chip—B; Orange Julius—F; Orange Cream—F; Peach Cobbler—F; Peanut Butter and Jelly—B; Peanut Brittle—B; Pecan Pie—B; Pineapple—F; Pineapple Upside down Cake—F; Praline—B; Pralines & Cream—B; Pumpkin Pie—B; Raspberry—F; Rocky Road ( Chocolate, Marshmallow)—B; Root Beer—B; Rum Cake—B; Smore's—B; Sorbet—F; Strawberry Cheesecake—F; Sugar Cookie—B; Super Banana Split—F; Toffee—B; Turtle (Chocolate, Caramel, Nuts)—B; Vanilla Ice Cream —B; Vanilla Custard—B; White Chocolate Macadamia Nut Cookie—B; White Chocolate Mousse—B.

PARTS LIST:

| | The following is a list of parts and materials suitable for use in the |
|---|---|
| | present invention: |
| 10 | snap-on sprayer assembly apparatus of the preferred embodiment of |
| | the present invention |
| 20 | spray assembly component of snap-on sprayer assembly apparatus 10 |
| | of the preferred embodiment of the present invention |
| 22 | nozzle |
| 30 | bottle of snap-on sprayer assembly apparatus 10 of the preferred |
| | embodiment of the present invention (made of, for example, |
| | polypropylene, PET, or polyethylene) |
| 31 | ridge on bottle 30 |
| 40 | cap of spray assembly component 20 (made of, for example, poly- |
| | propylene or polyethylene) |
| 50 | actuator (made of, for example, polypropylene or polyethylene) |
| 60 | snap-on closure |
| 61 | annular groove of closure 60 |
| 70 | springs (steel, e.g.) |
| 80 | ball (steel, e.g.) |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of assembling a sprayer comprising the steps of:
providing a bottle;
providing a sprayer assembly including a nozzle, pump assembly, and overcap;
placing the sprayer assembly on the bottle; and
pushing down on the overcap.

2. Sprayer apparatus comprising:
a sprayer assembly including a nozzle, pump assembly, and overcap; and
means on the sprayer assembly for connecting the sprayer assembly to a bottle.

3. The invention of any prior claim, wherein the bottle has a diameter of about 13 mm.

4. The invention of any prior claim, wherein the sprayer assembly snaps onto the bottle.

5. The invention of any prior claim, wherein the bottle contains sucralose in a candy-flavored spray form or in a dessert-flavored spray form.

6. A method of delivering a liquid composition including sucralose and flavoring agent(s) comprising:
placing the liquid composition including sucralose and flavoring agent(s) in a bottle;
providing a sprayer assembly including a nozzle, pump assembly, and overcap;
placing the sprayer assembly on the bottle;
pushing down on the overcap;
actuating the sprayer assembly to spray the liquid composition including sucralose and flavoring agent(s) from the bottle.

7. The invention of claims 5 or 6, wherein the liquid composition including sucralose and flavoring agent(s) is in an aqueous vehicle.

8. The invention of claim 7, wherein the liquid vehicle includes flavoring agents.

9. A method of delivering a liquid composition including sucralose and flavoring agent(s) comprising:
placing the liquid composition including sucralose and flavoring agent(s) in a bottle having a sprayer assembly including a nozzle;
actuating the sprayer assembly to spray the liquid composition including sucralose and flavoring agent(s) from the bottle.

10. The invention of claim 9, wherein the liquid composition including sucralose and flavoring agent(s) is in an aqueous vehicle.

11. The invention of claims 9 or 10, wherein the liquid composition includes flavoring agents.

12. The invention of claims 9 or 10, wherein the liquid composition includes a flavor from the group consisting of the following list of flavors:
Almond Cookie; Amaretto; Angel Food; Anise (Licorice Flavor); Apple Brown Betty; Apple Cinnamon Cobbler; Apple Dumpling; Apple Fritter; Apple Pie; Apple Streusel; Apricot; Baklava; Banana Bread; Banana Cream; Banana Cream Pie; Banana Nut Bread; Banana Split; Banana Strawberry; Berry Compote; Black Forest Cake (Chocolate and Cherries); Black Walnut; Blueberry Cheesecake; Bread Pudding; Butter Rum; Buttered Pound Cake; Butterscotch; Cappuccino; Caramel Custard; Caramel Pop Corn; Carrot Cake; Cheesecake; Cherries Jubilee; Cherry Cheesecake; Chocolate Almond; Chocolate Caramel Swirl; Chocolate Chip Cookie Dough; Chocolate Covered Cherries; Chocolate Covered Pretzels; Chocolate Layer Cake; Chocolate Mint Patty; Chocolate Peanut Butter Cups; Chocolate Raspberry; Chocolate Strawberry; Chocolate Strawberry, Raspberry and Almond; Chocolate Toffee; Chocolate Truffles; Cinnamon Apple Pie; Coconut Cream Pie; Coffee Flavor Cappuccino; Coffee Flavor Latte; Coffee Flavor Mint; Coffee Flavor Mocha; Coffee Flavor Orange; Cookies N Cream; Cranberry Pie; Cranberry Tart; Cranberry/Orange; Creampuff; Creamy Cheesecake; Creme Brulee; Creme De Menthe; Crepe Suzette; Divinity; Eggnog; Flan; Fruit Cake; Fruit Salad; Fudge; Fudge Brownie; Ginger Bread; Ginger Snap; Glazed Donut; Green Apple; Hot Buttered Rum; Hot Fudge Brownie; Hot Fudge Sundae; Ice Cream Cake; Jellybean; Key Lime Pie; King Cake; Lemon Meringue; Licorice; Maple Syrup; Maple Nut; Mint Chocolate Chip; Orange Julius; Orange Cream; Peach Cobbler; Peanut Butter and Jelly; Peanut Brittle; Pecan Pie; Pineapple; Pineapple Upside down Cake; Praline; Pralines & Cream; Pumpkin Pie; Raspberry; Rocky Road (Chocolate, Marshmallow); Root Beer; Rum Cake; Smore's; Sorbet; Strawberry Cheesecake; Sugar Cookie; Super Banana Split; Toffee; Turtle (Chocolate, Caramel, Nuts); Vanilla Ice Cream; Vanilla Custard; White Chocolate Macadamia Nut Cookie; White Chocolate Mousse.

13. The invention of claims 9 or 10, wherein the liquid composition includes a flavor from the group consisting of the following list of flavors: Chocolate Caramel Swirl, Chocolate Chip Cookie Dough, Chocolate Covered Cherries, Chocolate Peanut Butter Cups, Cinnamon Apple Pie, Cookies N Cream, Hot Fudge Brownie, Key Lime Pie, Lemon Meringue, Mint Chocolate Chip, Pralines & Cream, Strawberry Cheesecake, Super Banana Split.

14. The invention of any one of claims 9-13, wherein the sprayer assembly includes a manual pump system.

15. The invention of any one of claims 9-14, wherein the liquid composition is made according to the following formulation, where percentages are by weight of the liquid composition:

| | |
|---|---|
| deionized water | 39-67% |
| Sodium Benzoate | 0.0375-0.625% |
| Potassium Sorbate | 0.0375-0.625% |
| Sucralose | 0.075-.125% |
| Sodium Citrate | 0.1875-0.3125% |
| High Fructose Corn Syrup 55 | 26.25-43.75% |
| Extol N&A Flavor System | 4.50-7.50% |
| Vegetable Glycerine | 3.75-6.25% |
| Citric Acid, anhyd. | 0.1125-1.25% |

Artificial Color 0.075-0.125%.

16. A liquid composition made according to the following formulation, where percentages are by weight of the liquid composition:

| | |
|---|---|
| deionized water | 39-67% |
| Sodium Benzoate | 0.0375-0.625% |
| Potassium Sorbate | 0.0375-0.625% |
| Aspartame | 0.1875-0.3125% |
| Acesulfame K | 0.15-.25% |
| Sodium Citrate | 0.1875-0.3125% |
| High Fructose Corn Syrup 55 | 26.25-43.75% |
| Extol N&A Flavor System | 4.50-7.50% |
| Vegetable Glycerine | 3.75-6.25% |
| Citric Acid, anhyd. | 0.1125-1.25% |
| Artificial Color | 0.075-.125% |

17. A method for autogenously administering flavoring to a human subject concurrently with the use of a spray, comprising the steps of:
(a) forming a sprayable liquid composition as described in the specification herein; and
(b) spraying an amount of said composition into the mouth of said subject.

18. The invention of any one of claims 6-11, 16 and 17, wherein the liquid composition includes a flavor from the group consisting of the following list of flavors:
Almond Cookie; Amaretto; Angel Food; Anise (Licorice Flavor); Apple Brown Betty; Apple Cinnamon Cobbler; Apple Dumpling; Apple Fritter; Apple Pie; Apple Struesel; Apricot; Baklava; Banana Bread; Banana Cream; Banana Cream Pie; Banana Nut Bread; Banana Split; Banana Strawberry; Berry Compote; Black Forest Cake (Chocolate and Cherries); Black Walnut; Blueberry Cheesecake; Bread Pudding; Butter Rum; Buttered Pound Cake; Butterscotch; Cappuccino; Caramel Custard; Caramel Pop Corn; Carrot Cake; Cheesecake; Cherries Jubilee; Cherry Cheesecake; Chocolate Almond; Chocolate Caramel Swirl; Chocolate Chip Cookie Dough; Chocolate Covered Cherries; Chocolate Covered Pretzels; Chocolate Layer Cake; Chocolate Mint Patty; Chocolate Peanut Butter Cups; Chocolate Raspberry; Chocolate Strawberry; Chocolate Strawberry, Raspberry and Almond; Chocolate Toffee; Chocolate Truffles; Cinnamon Apple Pie; Coconut Cream Pie; Coffee Flavor Cappuccino; Coffee Flavor Latte; Coffee Flavor Mint; Coffee Flavor Mocha; Coffee Flavor Orange; Cookies N Cream; Cranberry Pie; Cranberry Tart; Cranberry/Orange; Creampuff; Creamy Cheesecake; Creme Brulee; Creme De Menthe; Crepe Suzette; Divinity; Eggnog; Flan; Fruit Cake; Fruit Salad; Fudge; Fudge Brownie; Ginger Bread; Ginger Snap; Glazed Donut; Green Apple; Hot Buttered Rum; Hot Fudge Brownie; Hot Fudge Sundae; Ice Cream Cake; Jellybean; Key Lime Pie; King Cake; Lemon Meringue; Licorice; Maple Syrup; Maple Nut; Mint Chocolate Chip; Orange Julius; Orange Cream; Peach Cobbler; Peanut Butter and Jelly; Peanut Brittle; Pecan Pie; Pineapple; Pineapple Upside down Cake; Praline; Pralines & Cream; Pumpkin Pie; Raspberry; Rocky Road (Chocolate, Marshmallow); Root Beer; Rum Cake; Smore's; Sorbet; Strawberry Cheesecake; Sugar Cookie; Super Banana Split; Toffee; Turtle (Chocolate, Caramel, Nuts); Vanilla Ice Cream; Vanilla Custard; White Chocolate Macadamia Nut Cookie; White Chocolate Mousse.

19. The invention(s) substantially as shown and/or described herein.
